(19) United States
(12) Patent Application Publication
(10) Pub. No.: US 2007/0054511 A1
(43) Pub. Date: Mar. 8, 2007

(54) Elastic connection wiring

(76) Inventor: Jean-Michel Ittel, Les Adrets (FR)

Correspondence Address: Robert E. Krebs;Thelen Reid & Priest LLP, P.O. Box 640640, San Jose, CA, 95164-0640, US

(21) Appl. No.: 11/127,956

(22) Filed: May 11, 2005

(30) Foreign Application Priority Data
May 13, 2004 (FR) 04 05194

(51) Int. Cl. H01R 12/00

(52) U.S. Cl. 439/66

(57) ABSTRACT

A connection system, particularly an electrical system, comprises inextensible wires to connect two elements, the wires being associated with an elastic support such that, when elastic deformation of the support occurs, wires remain fixed to the support. Therefore, the invention enables an elastic connection without shearing being caused between the support and the wires. Various embodiments and related manufacturing methods are described.

### TECHNICAL FIELD

The invention relates to connections by wire elements in an environment subjected to deformations.

In particular, the invention is applicable to connector technology in compounds affected by elastic deformations.

### BACKGROUND ART

Developments in electronics and data processing have led to an increased number of electrical connections, more generally known as connector technology. Many applications require an extendable connector technology due to the relative movements that occur between the connected elements.

One approach used for equipment that is not too sensitive is to release wires in the movement area: for example, wires for articulated arms (as in industrial robots) are fixed to the arms, but are left free at the articulation where they remain visible or are inserted in very wide jackets. However, this solution is only suitable for large and simple articulations with very precise positioning, and for elements and articulations protected as a result of their position.

One solution envisaged to prevent the above-mentioned loose wires involves the passage of connection wires in a preformed spiral jacket thus forming a flexible cable, for which the most representative example is telephone wire. The geometry of the jacket enables elongation of the cable and return to its initial shape when the elongation force disappears. However this solution has the disadvantage that it is quite large and that forming fatigue can occur during use. Furthermore, relative movement between wires and jacket can cause shear.

Another solution relates to manufacturing of resins and/or gums that themselves have electrical properties, for example due to the presence of conducting particles distributed within their body: the conducting polymeric substrate is then used directly as the connector technology. However, the shape of the support is modified during elongation: particularly in the simple case of a band, the thickness and width reduce during elongation. This modifies the distribution of conducting particles and the resistance of the substrate is not constant, and therefore the electrical signal is modified.

Thus there is a need for a so-called “elastic” connector technology in which the wire maintains electrical properties, particularly resistance and impedance, determined in advance when the medium in which it is located is deformed. Furthermore, there is a need to improve the life of the connection cables used with non-rigid supports, which is reduced by the shear resulting from relative displacement between two elements.

### PRESENTATION OF THE INVENTION

Among others, the advantages of this invention include overcoming the disadvantages inherent to existing solutions for the installation of inextensible electrical wires in deformable media.

More generally, this invention relates to elastic components with elongated elements in the form of wires or cables, more generally called “wires” in the following, which are not necessarily elastic, associated with an elastic support, and the method for manufacturing them. According to one of its aspects, the geometry of wire elements of a component according to the invention is such that when the support is deformed elastically, they accompany the modification to the support but without being affected by any movement relative to the support at the interface between the wire elements and the support. Due to this fixity of the wires with the support that can be qualified as being continuous, there is no shear force and therefore the component remains operative even after a large number of deformation cycles.

According to one of its aspects, the invention relates to an electrical connector technology, in other words in which the wire elements are electrical cables or wires, preferably non-extensible to maintain constant and defined electrical properties. However, other elements could be considered, for example including optical fibres.

The support material is chosen as a function of use, and particularly the required degree of elongation. The material is preferably isotropic. For example, silicone could be recommended in the medical field; one preferred choice for electrical connections is polyurethane which enables good integration of the jackets of electrical wires and has known and controlled elasticity properties.

It may be desirable to treat the surface of wires as a function of the chosen coating, in order to improve integration between the wires and the support and to increase adhesion.

Different geometries have been proposed for a component according to the invention.

Thus for example, the wires can be wound around an elastic core like a strand and fixed to it for example by gluing. When the core is elongated, the wires also give the impression of being extended due to the increase in the winding pitch. This geometry enables a large elongation depending on the diameter of the core and the winding pitch for the wires. The invention also relates to a method for making this component, with winding of the wire material around an elastic core and fixing it.

Another geometry of a component according to the invention relates to a plate shaped support on which the wires are arranged with a plane geometry. Advantageously, the wires do not touch each other to prevent any shear. The geometry of the wires is preferably in the form of undulations, with an amplitude and pitch that depend on the required elongation. The geometry is preferably uniform along the support so as to achieve controlled elongation properties. It is preferable to have a layer of elastic material, for example similar to the support, above the assembly formed by the support and the wiring, to maintain the predetermined geometry of the wires at rest.

According to another aspect, the invention relates to a component of this second type, in other words flat, inside which the wire elements are arranged in the form of helical windings. This enables greater elongation.

The invention also relates to a method of making the second type of component, in other words including placement of wire elements according to a predefined geometry on a plane substrate, and fixing of the wire elements to an elastic support.

### BRIEF DESCRIPTION OF THE DRAWINGS

Other characteristics and advantages of the invention will become clearer after reading the description and with reference to the attached drawings among which:

FIG. 1 shows the different elements and parameters useful for understanding the invention.

FIG. 2 shows a first embodiment of a component according to the invention.

FIGS. 3a, 3b and 3c show three possible configurations for the first embodiment.

FIGS. 4a and 4b show two configurations of the second embodiment of a component according to the invention.

FIG. 5 shows a third embodiment of a component according to the invention, FIG. 5a along the AA axis and FIG. 5b along the BB axis.

### DETAILED PRESENTATION OF PREFERRED EMBODIMENTS

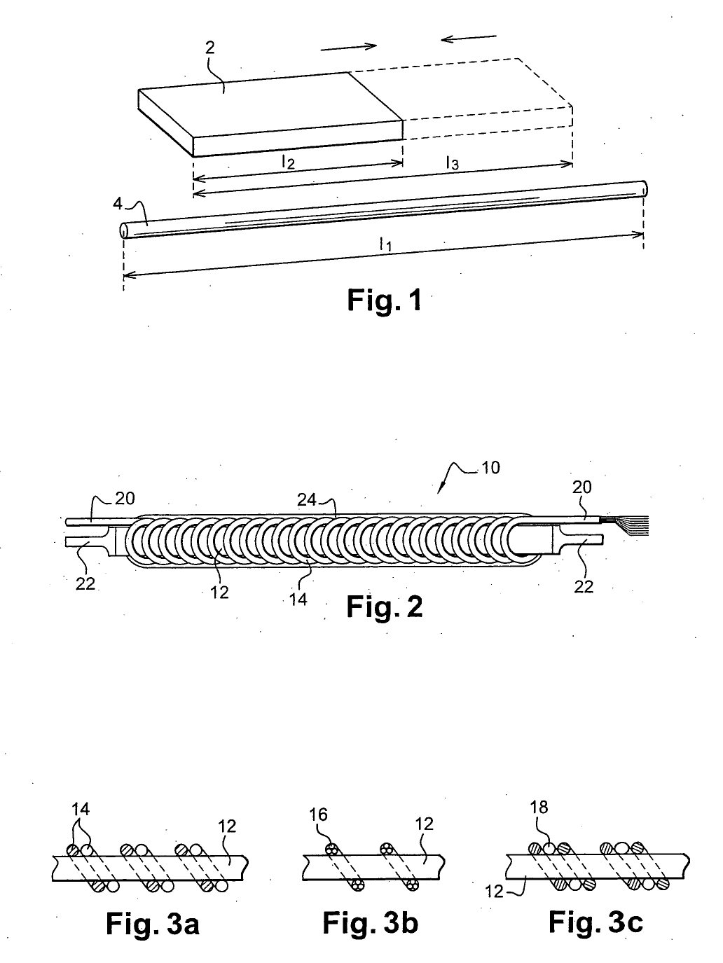

The invention relates to connection components including an elastic support 2 and wires 4 with lower elasticity as shown in FIG. 1, the term “wire” being used in the broad sense of the term, namely a “long thin strand”. Wires have an initial length l₁. As will become more obvious later, the term “connection components” also relates to entities that can be used individually as part of larger devices. In particular, components include an elastic support 2: this component support 2 may also be only part of a larger support used in a device including the connector technology according to the invention.

The support 2 has a second length l₂ at rest. During use of the device including the support 2, the length of the support 2 will change as a result of bending of the device, vibrations, or any other mechanical action, and particularly it will increase between l₂ and a third maximum length l₃. The length l₁ of the wires is chosen such that this support movement is possible, and therefore normally l₁≧l₃.

The invention is based on the fact that, unlike the known procedure followed by those skilled in the art, the wires are integrated with, associated with, in other words fixed to, the support such that there is no displacement between the wire surface and the surface of the support adjacent to it during elastic deformation of the support. Considering the difference in nature between the polymer of a jacket and the electrical conductors, in the past it has been envisaged to either modify or choose the nature of one of both elements so that the elastic behaviour of each one, is similar (conducting gum, coated wire in a preformed flexible jacket) or to dissociate them completely so as to enable relative movement between them (wire free to move in a wide jacket). In the context of the invention, the conductors deform in exactly the same way as the medium in which they are located, but the length of the wires themselves remains constant and their impedance does not change, and no overthicknesses or length absorption loops are formed by them. Fixity between the wire 4 and the support 2 is continuous, in other words it takes place along the second length l₂.

In the context of the invention, all the wires used may be available in the shops, or they may be made specifically for the purpose. The material for the support may be chosen in the same way from among known or specially developed materials and depends mainly on the required elasticity and resistance range: for example, a material with low resistance but capable of occasionally elongating by large amounts (see rubber elastics) could be chosen, or it may be preferable to use a very solid material capable of resisting a large number of deformation cycles and in which the elasticity is limited to a low elongation. In fact, using the parameters in FIG. 1, the material chosen will be elastic between the lengths l₂ and l₃, where l₂ is the length at rest, in other words in the absence of any tension stress. It is desirable that the support material should be isotropic in order to maintain a uniform behaviour regardless of the deformation direction, particularly along the entire length. Furthermore, it is preferable that it can be moulded to facilitate manufacturing, and without hysteresis. For example, it is possible to use a polyurethane, a rubber, a neoprene or silicone.

A variable value of the Shore hardness will be chosen, depending on the context in which the device will be used. For example, a material with a Shore hardness of the order of 40 could be chosen in an environment in which forces are high and low elongations (such as 1%) are necessary; and a material with a Shore hardness of 5 to 10 could be chosen for a less disturbed environment in which forces are lower and required elongations are greater, for example 100% elongation (such as articulations of the human body).

FIG. 2 shows a first possible embodiment also called a “strand” configuration 10. According to this embodiment, a central core 12 is manufactured from an elastic material chosen according to the criteria mentioned above, and the size (core length and diameter) also depends on the use that will be made of the component 10. Similarly, depending on use, the necessary wires 14 will be chosen (nature, number, length l₁ equal to at least the maximum length l₃ of the component 10). For example, it would be possible to choose commercially available shielded and/or telefonized electrical wires, and particularly coaxial wires.

The wires 14 are then wound manually around the central core 12, either manually or using a conventional method for stranding of wires and/or cords and/or cables, or any other technique known to those skilled in the art. The diameter and the pitch of turns in the strand will depend on the elongation to be compensated, and also on the core diameter. It is desirable that windings should be regular along the entire length of the core 12 so that the behaviour is as reproducible as possible.

Various configurations are possible; the wires 14 can be wound independently of each other, so as to obtain nested windings (FIG. 3a). The wires 12 may themselves be in the form of an assembly or cables 16; FIG. 3b thus shows a winding of cables 16 comprising three electrical wires. In this case, it is desirable for the diameter of cable 16 to remain very much smaller than the winding pitch. It is also possible to fix the different wires 14 before winding, for example by gluing, preferably in a plane configuration 18 (three wires in the example) and to wind this flat assembly 18 onto the core 12 (FIG. 3c). The advantage of this configuration is to keep a small diameter, while minimizing risks of relative movement.

The winding is made simultaneously or prior to gluing of wires 14 onto the core 12 so as to fix them and to prevent any relative movement at their contact points. The glue is preferably made of the same material as the core 12; it may also be liquid, for example for polyurethane. Fixity can also be achieved by moulding. Adhesion can be further improved by surface treatment of the wires 14, for example Teflon® surrounding coaxial shielded wires for integration into polyurethane.

Preferably, the ends 20 of the wires 14 are left free. The device can be elongated by “pulling” on the core 12, at one or both of its ends 22. Since the wires 14 are fixed to the core 12, the core twists as it is elongated and the apparent length of wires increases at the same time, as a result of the increase in pitch of their winding; there is mechanical decoupling between the forces applied to the core 12 and the wires 14. Therefore, the central core 12 absorbs the entire tension, and the conducting wires 14 are not at all stressed. Furthermore, the lack of relative movement between the core 12 and wire 14 assures long life of the component 10, depending only on the elasticity limits of the material chosen for the core 12 with no alteration due to the shear resulting from movements of the wires 14 along the interface between the wires 14 and the support 12.

The initial strand can be coated with an elastic material, for example by moulding, to increase the safety of the component 10. The modulus of elasticity of the coating 24 is preferably greater than the modulus of elasticity of the central core 12; this assures that there is no stress on the conducting wires 14 and does not modify the elongation properties of the strand 10.

Although theoretically unlimited, there are practical limits to the strand configuration 10 for a large number of wires, for example about 12 wires; the diameter of the assembly then becomes large and it may be difficult to integrate the component into a device for use.

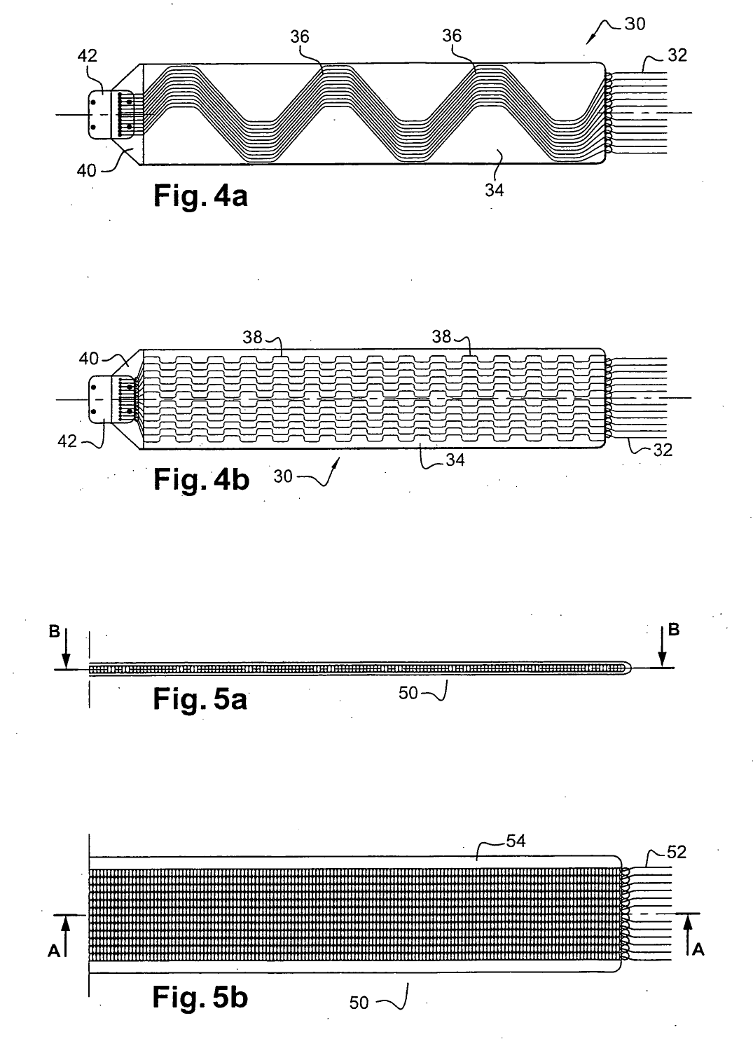

The component according to the invention may be made in another configuration called a “wave” configuration 30, for example shown in FIG. 4; in this embodiment, the wires 32 are arranged on a plane and are fixed to a flat support 34. Therefore, the thickness is reduced.

In the same way as above, the length and number of wires, the material from which the support is made and its dimensions depend on the required elongation and use—in this case, it is preferable in particular if the material used for the support 34 is as similar as possible to the product in which the component 30 will be used, or possibly the component 30 may be manufactured inside and as part of the final device.

The wires 32 are arranged side by side on a substrate to form a set of flat conductors. The geometry depends on the required elongation and the difference in length between the support 34 and the wires 32 (between l₂ and l₁); modelling is easy to obtain the wave parameters. It is preferable if the wires 32 do not touch each other so as to prevent any shear between two wires during stretching; therefore it is desirable for each wire to follow a path parallel to the path of the adjacent wire.

Two main configurations are described in detail for this embodiment; depending on the size of the “waves”, in other words particularly their amplitude, each wire is “nested” in another (“ribbon” 36 in FIG. 4a) or the wires form separate “undulating rails” 38 (FIG. 4b). The two configurations may be mixed within the same device 30, for example with a ribbon 36 of six wires surrounded by undulations 38 on each side. In particular, the choice of the geometry depends on the initial conductors (length, nature) and the manufacturing method chosen to make the wave pattern; thus for a ribbon 36, it would be possible to fix the wires 32 on a plane in the same way as for the strand 10 in FIG. 3c and then to position the wires according to the pattern. One possible means of making low amplitude undulations 38 in FIG. 4b would be to pass the wire 32 along a toothed gear arrangement.

In order to achieve regular behaviour over the entire length of the component 30, it is desirable that the undulations 36, 38 should have a constant amplitude and interval throughout the length of the support 34.

After all the wires 32 have been arranged on the surface of the substrate, they are integrated into an elastic material forming the support 34, preferably by moulding and/or injection. The same precautions and possibilities are applicable as for the strand 10.

The substrate on which the wires were arranged can be of the same nature as the elastic material, in other words the support 34; the result when moulding occurs is then a support 34 comprising the initial substrate and the added product, inside which the conductors 32 are integrated on a plane. In this case, it might be desirable to glue the wires onto the substrate forming the lower part of the support 34 before the material that will form the upper part of the support 34 is injected; the glue used may be polyurethane, rubber, liquid, or paste.

It is possible to proceed to a geometry transfer to further reduce the final thickness, the substrate simply being used to position the wires 32 before they are moulded from an elastic material forming the support 34. In this case, the wires 32 of the component 30 are practically on its surface. In this case it would be possible to apply the coating in the same way as for the strand 10.

Unlike the strand 10 type embodiment, in the second embodiment it is no longer possible to dissociate the support 34 from the wires 32 when elongation forces are applied; “pulling” on the support 34 effectively “pulls” on the wires 32. It is desirable that at least one of the ends of the support 34 should be prolonged so that the force can be recovered and any stress causing shearing on the wires 32 and possibly breakage is eliminated. For example, the prolongation 40 may be moulded at the same time as the support 34 and the ends of the wires 32 may be fixed to it, for example to be connected to a plate 42 or a sensor. The waves can be arranged in this prolongation to compensate for forces due to tension.

FIG. 5 shows a third embodiment 50 combining aspects of the above two embodiments; instead of being arranged flat on a substrate, the wires 52 are in the form of spirals or windings. The arrangement of the wires 52 on the substrate may be made with wires only that are wound and maintain their geometry, or wires can be wound on a core as in the first embodiment. In this case, it is preferable if the core is of the same nature as the material subsequently used for the support 54, so that during moulding, the two elements combine together and nest one into the other, which correspondingly increases adhesion of the wires 52 to the support 54. The result is then an intermediate structure 50 that can comprise a large number of wires 52 determining the width of the support 54, with a thickness intermediate between the thickness of the strand 10 and the wave configuration 30.

Regardless of the chosen embodiment, it is clear that maximum adhesion must be achieved at contact points between the support 12, 34, 54 and the wires 14, 32, 52. Depending on the required elongation and the number of cycles that will be applied to the component 10, 30, 50 (repeated low amplitude vibrations are actually worse for shear forces than occasional extreme elongations), it may be desirable to eliminate any gaseous residue within the material, particularly for polymer material, from which the support and glue (if any) are made, to prevent any air bubbles around a wire; therefore the moulding and/or continuous gluing step of the wires 14, 32, 52 on the core 12 and/or on the support 34, 54 may be combined with degassing operations known to those skilled in the art.

There are many applications of such a type of connection 10, 30, 50. In particular, in avionics and more generally in the field of transport (for persons and conveyors on industrial manufacturing lines), the component according to the invention can be used for elastic deformation of some jackets containing electrical wires while avoiding shear problems inherent to repeated vibrations which, with known connections, cause deterioration due to relative movements between the wire and the support surrounding it.

Similarly, the component may be used in the medical field, for example joint prostheses. In this case, it is possible to glue a component according to the invention at the joint concerned, for example to connect a sensor to movement activation or control means. It is also possible to integrate the component directly into the prosthesis or the medical apparatus, for example by selecting silicone as a support if integration is envisaged into a silicone-coated catheter.

Although the above description and drawings relate to electrical wires integrated into an elastic connector technology, the invention is not limited to this embodiment but includes elements that do not go outside the scope of the claims.

In particular, all or some of the electrical wires can be replaced by any element with an elongated shape like a wire, that is inextensible or at least is not sufficiently extensible for the use made of them, intended for use within the context of a connection on an elastically deformable support.

One example is the use of single-mode or multi-mode optical fibres; parts subject to large deformations may be necessary in medical applications (for example in endoscopy) and in industrial applications (for example monitoring of hydraulic circuits) or submarine applications (for examples movie cameras). The component according to the invention can be used to replace existing articulations. Particularly, during repeated use, integration of fibres into a support for a component according to the invention provides a means of reducing the diameter while increasing the life due to the lack of shear forces between the protection jacket and the optical fibres.

Due to its compactness and resistance during deformation cycles, the component according to the invention can also be used in the clothing industry; sensors inserted at locations remote from their control means or accessories running over a certain length can be fitted into clothes and particularly shoes or diving suits.

1. Connection component comprising at least one wire with a first length and a support with a second length, the second length being shorter than the first length, the support being made from a material which is elastic between the second length at rest and a third length, the wire being fixed continuously to the support such that, when elastic deformation of the support occurs between the second length and the shortest of the first length and the third length, there is no relative displacement of the wire from the support at the interface between the wire and the support.

2. Component according to claim 1, in which the support is an elongated core.

3. Component according to claim 2, in which each wire forms a winding around the core.

4. Component according to claim 3, comprising several wires fixed to each other, the set of wires forming a winding with non-zero pitch around the core.

5. Component according to claims 3, comprising an elastic material coating around the core and wires.

6. Component according to claim 1, comprising a plane defined by the wires over the length of the support.

7. Component according to claim 6, in which the plane is located inside the elastic material support.

8. Component according to claim 6, comprising a plurality of wires such that no wire is in contact with another wire.

9. Component according to claim 8, in which the wires form parallel paths.

10. Component according to claim 6, in which each wire is in the form of undulations in the plane on at least part of the second length of the support.

11. Component according to claim 10, in which the elongations extend over the entire length of the support.

12. Component according to claim 10, in which the amplitude and intervals between undulations are regular.

13. Component according to claim 6, comprising also a prolongation of the support that could possibly be used to connect the component and/or exert a tension.

14. Component according to claim 1, comprising at least two wires, each wire being in the form of a helical winding, the entire windings being located inside the support.

15. Component according to claim 14, comprising also a prolongation of the support that could possibly be used to connect the component and/or exert a tension.

16. Component according to claim 1, in which the wires are inextensible.

17. Component according to claim 16, in which the wires are chosen from among coaxial cables or optical fibres.

18. Component according to claim 1, in which the support is made from polyurethane or silicone or rubber.

19. Component according to claim 1, in which the support is isotropic.

20. Elastic connector technology comprising a component according to claim 1, in which at least one wire is an electrical conductor, each conductor having prolongations outside the support at least on one side so as to enable its electrical connection.

21. Method for manufacturing an elastic connection component including positioning of wires according to a determined geometry, and continuous fixing of wires to an elastic material acting as a support so as to prevent any displacement between the wire surface and the support surface adjacent to wires when deformation of the support occurs.

22. Method according to claim 21, including shaping of an elongated core made from an elastic material, winding of wires with lower elasticity than the support around the core, and fixing of wires to the core.

23. Method according to claim 21, comprising placement of wires according to a predetermined geometry in a plane, then fixing of the geometry by moulding in an elastic support.

24. Method according to claim 21 including treatment of the wire surface before fixing.

25. Connection component comprising a support made from polyurethane or silicone or rubber which is elastic between a length at rest and a maximum length, a plurality of coaxial cables or optical fibres with a length at least equal to the maximum length of the support and which are not in contact with one another, the cables and fibres being fixed continuously to the support such that they do not move relative to the support at their interface when elastic deformation of the support occurs.

26. Component according to claim 25 in which the cables and fibres lie on a plane inside the support.
